(19) United States
(12) Patent Application Publication
(10) Pub. No.: US 2014/0372480 A1
(43) Pub. Date: Dec. 18, 2014

(54) INTERACTIVE CONTENT SEARCH USING COMPARISONS

(71) Applicant: THOMSON LICENSING, Issy de Moulineaux (FR)

(72) Inventors: Laurent Massoulie, Vaucresson (FR); Efstratios Ioannidis, San Francisco, CA (US)

(73) Assignee: Thomson Licensing, Issy de Moulineaux (FR)

(21) Appl. No.: 14/374,698

(22) PCT Filed: Feb. 6, 2013
(86) PCT No.: PCT/US2013/024881

§ 371 Date: Jul. 25, 2014

Related U.S. Application Data
(60) Provisional application No. 61/595,502, filed on Feb. 6, 2012.

(51) Int. Cl. G06F 17/30

(52) U.S. Cl. CPC G06F 17/30451
USPC 707/774

(57) ABSTRACT

In interactive content search through comparisons, a search for a target object in a database is performed by finding the object most similar to the target from a small list of objects. A new object list is then presented based on the earlier selections. This process is repeated until the target is included in the list presented, at which point the search terminates. A solution to the interactive content search problem is provided under the scenario of heterogeneous demand, where target objects are selected from a non-uniform probability distribution. It has been assumed that objects are embedded in a doubling metric space which is fully observable to the search algorithm. Based on these assumptions, an efficient comparison-based search method is provided whose cost in terms of the number of queries can be bounded by the doubling constant of the embedding c, and the entropy of demand distribution, H. More precisely, the present principles show that the average search costs scales C_{F}=O(c⁵H), which improves upon the previously best known bound and is order optimal for constant c.

### CROSS-REFERENCE TO RELATED APPLICATIONS

This application claims the benefit of U.S. Provisional Application Ser. No. 61/595,502, filed Feb. 6, 2012, which is incorporated by reference herein in its entirety.

### TECHNICAL FIELD

The present principles relate to interactive content search through comparisons.

### BACKGROUND OF THE INVENTION

Content search through comparisons is a special case of nearest neighbor search (NNS). The principles described herein extend earlier work by considering the NNS problem for objects embedded in a metric space. It is also assumed that the embedding has a small intrinsic dimension, an assumption that is supported by many practical studies. Prior works consider navigating nets, a deterministic data structure for supporting NNS in doubling metric spaces. A similar technique has also been considered for objects embedded in a space satisfying a certain sphere-packing property, while other work has relied on growth restricted metrics. All of the above assumptions have connections to the doubling constant considered herein. In all of the previous work, the demand over the target objects is assumed to be homogeneous.

NNS with access to a comparison oracle has been studied previously. A considerable advantage of previous studies is that the assumption that objects are a-priori embedded in a metric space is removed; rather than requiring that similarity between objects is captured by a distance metric, the prior works only assume that any two objects can be ranked in terms of their similarity to any target by the comparison oracle. Nevertheless, these works also assume homogeneous demand, so the principles herein are an extension of searching with comparisons to heterogeneity. In this respect, a heterogeneous demand distribution is a starting point for the principles herein. Under the assumptions that a metric space exists and the search algorithm is aware of it, the present principles improve average search cost. The main problem some prior works is that their approach is memoryless, i.e., it does not make use of previous comparisons, whereas the present principles solve this problem by deploying an ε-net data structure.

Pairwise comparisons between images has been previously proposed. It was then extended to the context of content search. The use of comparison oracle is not limited only to content retrieval/search. An individuals' rating scale tends to fluctuate a lot. In addition, ratings scales may vary between people. For these reasons it is more natural to use the pairwise comparisons as the basis for the recommendation systems. The advantages of this approach and the challenges of how to make such a system operational have been well described.

### SUMMARY OF THE INVENTION

These and other drawbacks and disadvantages of the prior art are addressed by the present principles, which are directed to a method for interactive content search through comparisons.

According to an aspect of the present principles, there is provided a method for searching content within a data base. The method is comprised of steps for constructing a net having a size containing a target, choosing a plurality of exemplars, comparing each exemplar with every other exemplar, and determining the exemplar closest to the target. The method is further comprised of steps of reducing the size of the net to a smaller size that contains the target. The method is further comprised of a step of repeating the choosing, comparing, determining, and reducing steps until the size of the net is small enough to locate the target.

According to another aspect of the present principles, there is provided an apparatus for searching content within a data base. The apparatus is comprised of a computer that performs the steps comprising the method described herein. The computer can be comprised of circuitry to construct a net having a size that contains a target. The computer can also be comprised of circuitry to choose a plurality of exemplars, and comparator circuitry that operates on the exemplars. The computer also comprises a determining circuit that finds the exemplar closest to the target and circuitry to reduce the size of the net to a smaller size that contains the target. The computer also comprises control circuitry to cause the circuitry to construct a net, the circuitry to choose exemplars, the comparator circuitry, the determining circuitry, and the circuitry to reduce the size of the net to repeat their operation if a terminal condition has not been reached.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows one embodiment of a method for performing a content search under the present principles.

FIG. 2 shows an apparatus for performing a content search under the present principles.

FIG. 3 shows an exemplary embodiment of elements comprising the apparatus of FIG. 2.

### DETAILED DESCRIPTION OF THE INVENTION

The present principles are directed to a method and apparatus for interactive content search through comparisons. The method is termed “interactive” because there are repeated stages of interacting with the results of a previous stage. The method navigates through a database of objects (e.g., objects, pictures, movies, articles, etc.) having certain measureable characteristics using comparisons. In particular, the method determines, from two objects at a time, the one closest to the target (e.g., a picture or movie or article, etc.) Closeness to the target, i.e. distance, can be measured in a number of ways, such as absolute difference, sum of absolute differences, etc. Based on the selection, the method selects a new pair of objects, and the process is repeated in similar stages until the pair of objects contains the desired target. In each stage, a small list of objects is presented for comparison. One object among the list is selected as the object closest to the target; a new object list is then presented based on earlier selections. This process continues until the target is included in the list presented, at which point the target is found and the search terminates.

In an alternative embodiment, the process can be repeated for a certain number of iterations, or until the selected object is within a threshold distance of the desired target. Also, an alternative method can be used to locate the target within the net after the net has been reduced so that all of its objects are within a threshold distance of the target.

The method requires:

1) A metric embedding of the objects, i.e., a representation of the objects in a metric space describing their features. For example, this could be the pixel values of the image objects. The distance in this metric space captures how “similar” or “close” objects are.

2) The results of the comparisons at each stage indicating which objects are closest to the target

At each stage, the method generates a new pair of objects to propose as target possibilities.

The proposed objects can be used in a next iteration of the method, or if they contain the target or are close enough to a desired target, the search can be stopped.

In simple terms, the method constructs a tree that organizes objects in a hierarchy. Nodes in this tree at that lie in the same level “cover” roughly equal sized regions of the metric space in which objects are represented. The method proceeds by proposing pairs of objects in the first layer of the tree: identifying which of the objects in this level of the tree is closest to the target narrows down the selection of objects that lie below this object in the hierarchy. The method then proceeds recursively by proposing pairs of objects among the children of this node.

The proposed method has the following properties:

1) It finds the sought out object quickly, within a few pairs proposed.

2) The guarantees that it provides work for non-homogenous demand: that is, it works even if some objects are more likely to be chosen than others.

Compared to earlier work in this area, the present method has better guarantees, so that it finds objects faster. The present method requires knowledge of the entire metric space, whereas earlier methods required knowledge of the order of distances between objects and a target, although not the exact numerical values of these distances. The present method does not require knowledge of the likelihood an object may be chosen, while earlier methods do. The present method also implements a fundamentally different algorithm than earlier work in this area.

This kind of interactive navigation, also known as exploratory search, has numerous real-life applications. One example is navigating through a database of pictures of people photographed in an uncontrolled environment, such as the databases Fickr or Picasa. Automated methods may fail to extract meaningful features from such photos. Moreover, in many practical cases, images that present similar low-level descriptors (such as SIFT features) may have very different semantic content and high level descriptions, and thus be perceived differently by users.

On the other hand, a human searching for a particular person can easily select from a list of pictures the subject most similar to the person she has in mind. Formally, the behavior of a human user can be modeled by a so-called comparison oracle. In particular, assume that that the database of pictures is represented by a set N endowed with a distance metric d. This metric captures the “distance” or “dissimilarity” between pictures of different people. The oracle/human has a specific target tεN in mind, and can answer questions of the following kind: “Between two objects x and y in N, which one is closest to t under the metric d?”

The goal of interactive content search through comparisons is thus to find a sequence of proposed pairs of objects to the oracle/human that leads the target object with as few queries as possible.

The principles described herein consider the problem under the scenario of heterogeneous demand, where the target object tεN is sampled from a probability distribution μ. In this setting, interactive content search through comparisons has a strong relationship to the classic “twenty-questions game” problem. In particular, a membership oracle is an oracle that can answer queries of the following form: “Given a subset A⊂N, does t belong to A?”

It is well known that to find a target t one needs to submit at least H(μ) queries, on average, to a membership oracle, where H(μ) is the entropy of μ. Moreover, there exists an algorithm (Huffman coding) that finds the target with only H(μ)+1 queries on average.

Content search through comparisons departs from the above setup in assuming that the database N is endowed with the metric d. A membership oracle is stronger than a comparison oracle as, if the distance metric d is known, comparison queries can be simulated through membership queries. On the other hand, a membership oracle is harder to implement in practice: unless A can be expressed in a concise fashion, a user will answer a membership query in linear time in |A|. This is in contrast to a comparison oracle, for which answers can be given in constant time. In short, our study of search through comparisons seeks similar performance bounds to the classic setup (a) for an oracle that is easier to implement and (b) under an additional assumption on the structure of the database (namely, that it is endowed with a distance metric).

Intuitively, the performance of searching for an object through comparisons will depend not only on the entropy of the target distribution, but also on the topology of the target set as described by the metric d. In particular, it has been established that Ω(cH(μ)) queries are necessary, in expectation, to locate a target using a comparison oracle, where c is the so-called doubling-constant of the metric d. Moreover, a scheme exists that locates the target in O(c³H log(1/μ*) queries, in expectation, where μ*=min_{xε}Nμ(x). Under the principles herein, an improvement on the previous bound is achieved by proposing an algorithm that locates the target with O(c⁵H(μ)) queries, in expectation.

### DEFINITIONS AND NOTATION

Consider a set of objects N, where |N|=n. We assume that there exists a metric space (M,d), where d(x,y) denotes the distance between x,yεM, such that objects in N are embedded in (M,d): i.e., there exists a one-to-one mapping from N to a subset of M.

The objects in N may represent, for example, pictures in a database. The metric embedding can be thought of as a mapping of the database entries to a set of features (e.g., the age of person depicted, her hair and eye color, etc.). The distance between two objects would then capture how “similar” two objects are w.r.t. these features. In what follows, some notation will be written as N⊂M, keeping in mind that there might be difference between the physical objects (the pictures) and their embedding (the attributes that characterize them).

### A. Comparison Oracle

A comparison oracle is an oracle that, given two objects x,y and a target t, returns the closest object to t. More formally,

$$Oracle ( x , y , t ) = \{ \begin{matrix}x & if d ( x , t ) < d ( y , t ) , \\ y & if d ( x , t ) > d ( y , t ) \\ x or y & if d ( x , t ) = d ( y , t ) .\end{matrix} \qquad ( 1 )$$

Observe that if x=Oracle(x,y,t) then d(x,t)≦d(y,t); this does not necessarily imply however that d(x,t)<d(y,t).

It is important to note here that although it is written Oracle(x,y,t) to stress that a query always takes place with respect to some target t, in practice the target is hidden and only known by the oracle. Alternatively, following the “oracle as human” analogy, the human user has a target in mind and uses it to compare the two objects, but never discloses it until actually being presented with it.

### B. Demand, Entropy and Doubling Constant

A probability distribution μ over the set of objects in N which can be called the demand. In other words, p will be a non-negative function such that Σ_{tε}Nμ(t)=1. In general, the demand can be heterogeneous as μ(t) may vary across different targets. The target distribution μ will play an important role in the following analysis. In particular, two quantities that affect the performance of searching in the described scheme will be the entropy and the doubling constant of the target distribution. These two notions are defined formally below.

The entropy of μ is defined as

$$H ( μ ) = {\sum }_{x ∈ supp ( μ )} μ ( x ) log \frac{1}{μ ( x )} , \qquad ( 2 )$$

where supp(μ) is the support of μ. The max-entropy of μ is defined as

$${H}_{max} ( μ ) = {max}_{x ∈ supp ( μ )} log \frac{1}{μ ( x )} . \qquad ( 3 )$$

Given an object xεN, the closed ball of radius R≧0 around x is denoted by

Bₓ(R)={yεM:d(x,y)≦R} (4)

### Given a set A⊂N let

$$μ ( A ) = {\sum }_{x ∈ A} μ ( x ) .$$

The doubling constant c(μ) of a distribution μ is defined to be the minimum c>0 for which

μ(Bₓ(2R))≦c·μ(Bₓ(R)), (5)

for any x εsupp(μ) and any R≧0. Moreover, it can be said that μ is c-doubling if c(μ)=c.

Note that, contrary to the entropy H(μ), the doubling constant c(μ) depends on the topology of supp(μ), determined by the embedding of N in the metric space (M,d).

TABLE I
SUMMARY OF NOTATION

| | |
|---|---|
| N | Set of objects |
| (M, d) | Metric space |
| d(x, y) | Distance between x, y ∈ M |
| μ | The demand distribution |
| H(μ) | The entropy of μ |
| Hₘₐₓ(μ) | The max-entropy of μ |
| Bₓ(r) | The ball of radius r centered at x |
| c(μ) | The doubling constant of μ |

In formulating the problem, the notation of prior works in this area is followed. Given access to a comparison oracle, it is desired to navigate through N until a target object is found. In particular, a greedy content search is defined as follows. Let t be the target object and s some object that serves as a starting point. The greedy content search algorithm proposes an object w and asks the oracle to select, between s and w, the object closest to the target t, i.e., it evokes Oracle(s,w,t). This process is repeated until the oracle returns something other than s, i.e., the proposed object is “more similar” to the target t. Once this happens, say at the proposal of some w′, if w′≠t, the greedy content search repeats the same process now from w′. If at any point the proposed object is t, the process terminates.

More formally, let xₖ,yₖ be the k-th pair of objects submitted to the oracle: xₖ is the current object, which greedy content search is trying to improve upon, and yₖ is the proposed object, submitted to the oracle for comparison with xₖ. Let

oₖ=Oracle(xₖ,yₖt)ε{xₖ,yₖ}

be the oracle's response, and define

Hₖ={(x_{i ,y}_{i ,o}ᵢ)}ᵢ^{k}, k=1,2 . . .

to be the sequence of the first k inputs given to the oracle, as well as the responses obtained. Hₖ is the “history” of the content search up to and including the k-th access to the oracle.

The starting object is always one of the first two objects submitted to the oracle, i.e., x₁=s. Moreover, in greedy content search,

xₖ₊₁=oₖ, k=1,2 . . .

i.e., the current object is always the closest to the target among the ones submitted so far.

On the other hand, the selection of the proposed object yₖ₊₁ will be determined by the history Hₖ and the object xₖ. In particular, given Hₖ and the current object xₖ there exists a mapping (Hₖ,xₖ)→F(Hₖ,xₖ)εN such that

yₖ₊₁=F(Hₖ,xₖ), k=0,1, . . . ,

where here x₀=sεN (the starting object) and H₀=φ (i.e., before any comparison takes place, there is no history).

The mapping F is called the selection policy of the greedy content search. In general, if the selection policy is allowed to be randomized; in this case, the object returned by F(Hₖ,xₖ) will be a random variable, whose distribution

Pr(F(Hₖ,xₖ)=w), wεN, (6)

is fully determined by (Hₖ,xₖ). Observe that F depends on the target t only indirectly, through Hₖ and xₖ; this is consistent with the assumption that t is only “revealed” when it is eventually located.

A selection policy is said to be memoryless if it depends on xₖ but not on the history Hₖ. In other words, the distribution is the same when xₖ=xεN, irrespective of the comparisons performed prior to reaching xₖ.

Assuming that when xₖ=t, the search effectively terminates (i.e., the human reveals that this is indeed the target), the desired goal is to select F so that the number of accesses to the oracle is minimized. In particular, given a target t and a selection policy F, the search cost is defined:

C_{F}(t)=inf{k:xₖ=t}.

to be the number of proposals to the oracle until t is found. This is a random variable, as F is randomized; let E[C_{F}(t)] be its expectation. The Content Search Through Comparisons problem is then defined as follows:

CONTENT SEARCH THROUGH COMPARISONS (CSTC): Given an embedding of N into (M,d) and a demand distribution μ(t), select F that minimizes the expected search cost

$${\overline{C}}_{ℱ} = {\sum }_{t ∈ 𝒩} μ ( t ) 𝔼 [ {C}_{ℱ} ( t ) ] .$$

Note that, F as is randomized, the free variable in the above optimization problem is the distribution.

### A Lower Bound and a Memoryless Algorithm

A lower bound on the expected number of queries that one needs to submit to a comparison oracle to locate a target t has been established previously by the inventors.

Theorem 1. For any integer K and D, there exists a metric space (M,d) and a target measure μ with entropy H(μ)=K log(D) and doubling constant c(μ)=D such that the average search cost of any selection policy F satisfies

$${\overline{C}}_{ℱ} \geq H ( μ ) \frac{c ( μ ) - 1}{2 log ( c ( μ ) )} . \qquad ( 7 )$$

Interestingly, a simple memoryless selection policy satisfies an upper bound that is within an O(c²(μ)Hₘₐₓ(μ)) factor of this bound.

Algorithm 1. Memoryless Content Search

Input: oracle(·, ·, t), demand distribution μ, starting object s.
Output: target t. 1: x ← s
2: while x ≠ t do
3: Sample y ε [symbol] from the probability distribution
${Pr}_{x} ( y ) ∝ \frac{μ ( y )}{μ ( {B}_{x} ( d ( x , y ) ) )} . \qquad ( 8 )$
4: x ← Oracle(x, y, t).
5: end while

Theorem 2. The expected search cost of Algorithm 1 is bounded by C_{F}≦6c³(μ)·H(μ)·Hₘₐₓ(μ).

There are several interesting observations to be made about Algorithm 1. To begin, the memoryless selection policy has the following appealing properties. For two objects y,z that have the same distance from x, if μ(y)>μ(z) then y has a higher probability of being proposed. When two objects y,z are equally likely to be targets, if d(y,x)<d(z,x) then y has a higher chance of being proposed. The distribution (8) thus biases both towards objects close to x as well as towards objects that are likely to be targets.

Moreover, in implementing the policy outlined in Algorithm 1, it is assumed that, at each x, a random y can be sampled from distribution (8). This assumes that the distribution μ and the embedding (or the distance metric d) are a-priori known. However, it is in fact true that Algorithm 1 can be implemented even if only the ordering relationships between objects, rather than their actual distances between targets, are known. This is important, as the latter can be obtained by only accessing a comparison oracle. In particular, all such ordering relationships can be revealed by asking |N|log|N| oracle queries offline (e.g., during a training phase).

As noted, the main discrepancy factor between the upper bound in Theorem 2 and the lower bound in Theorem 1 is of the order of c³Hₘₐₓ. The next result, appearing in the next section eliminates the Hₘₐₓ term at the expense of a dependence on the doubling dimension through an O(c⁵) term.

### An Algorithm Based on ε-Nets

The objective in this section is to establish that comparison-based search can compete in identifying an object target tεN initially sampled according to probability distribution μ in a number of steps C_{F} whose average value C_{F} verifies

C_{F}≦H(μ)c^{k}(μ)

for some fixed exponent k to be identified. To this end, a number of intermediate results are established.

### A. ε-Nets

ε-Nets are defined as follows:

Definition 1. An ε-net of a subset A⊂N is a maximal collection of points {x₁, . . . x₅} of A such that for i≠j, d(xᵢ,xᵢ)>ε.

In order to construct an ε-net, one needs to have access to the underlying metric space and the distance d between any two points. The construction of the net can happen in a greedy fashion in O(K|A|) time, where K the size of the ε-net. There are in fact efficient algorithms that can construct such nets.

Lemma 1. Given a ball Bₓ(R)⊂N, and an integer l>0, any (R/2^{l})-net {x₁, . . . xₖ} of Bₓ(R) is such that:

Bₓ(R)⊂Uᵢ₌₁^{k}Bₓ_{ᵢ}(R/2^{l}), (9)

and for all i≠j

Bₓ_{ᵢ}(R/2^{l+1})∩Bₓ_{ⱼ}(R/2^{l+1})=0. (10)

Moreover, the cardinality k of any such (R/2^{l})-net is at most c^{l+3}.

Proof: If (9) does not hold, then there exists y in Bₓ(R) such that d(y,xᵢ)>R/2^{l} for all i=1, . . . , k. This contradicts the maximality of {x₁, . . . , xₖ}.

For all i#j, any point z in the intersection Bₓᵢ(R/2^{l+1})∩Bₓⱼ(R/2^{l+1}) is such that

d(xᵢ,xⱼ)≦d(xᵢ,c)+(xⱼ,c)≦2R/2^{l+1}=R/2^{l}.

This contradicts the property that d(xᵢ,xⱼ)>R/2^{l}, hence the intersection Bₓᵢ(R/2^{l+1})∩Bₓⱼ(R/2^{l+1}) is necessarily empty.

Finally, property (10) implies

$$μ ( {⋃}_{i = 1}^{k} {B}_{{x}_{i}} ( R / {2}^{𝓁 + 1} ) ) = {\sum }_{i = 1}^{k} μ ( {B}_{{x}_{i}} ( R / {2}^{𝓁 + 1} ) ) .$$

On the other hand, applying l+2 times the fact that p is c-doubling, then for all i=1, . . . , k,

μBₓᵢ(R/2^{l+2})≧c₋ₜ₋₂μBₓᵢ(2R)

≧c^{-t-2}μBₓ(R),

because of the fact that Bₓ(R)⊂Bₓᵢ(2R), which follows from xᵢ εBₓ(R). To conclude, note that

∪ᵢ₌₁^{N}Bₓ_{ᵢ}(R/1^{l+1})⊂Bₓ(2R).

### Then:

cμ(Bₓ(R))≧μ(Bₓ(2R))

≧μ(∪ᵢ₌₁^{k}Bₓ_{ᵢ}(R/2^{l+1}))

≧kc^{-l-2}μ(Bₓ(R)).

The upper bound k≦c^{l+3} follows immediately.

The following is now necessary:

Lemma 2. Let δε(0,1) verify δ>⅓. Let the ball Bₓ(R) be such that there exists a yεB for which d(x,y)=R and μ({y})>0. Then the following holds. Let ρ>0 be such that ρ<min(δ,(1−δ)/2)R, and let l>0 be a positive integer such that

$${2}^{𝓁} ( \frac{R}{2} - \frac{ρ}{1 - δ} ) > R \frac{2 - δ}{1 - δ} . \qquad ( 11 )$$

Then for any zεBₓ(R), one has

$$μ ( {B}_{z} ( \frac{ρ}{1 - δ} ) ) \leq ( 1 - {c}^{- 𝓁} ) μ ( {B}_{x} ( \frac{R}{1 - δ} ) ) . \qquad ( 12 )$$

Proof: Let zεBₓ(R) be fixed. Let

$${B}^{′} := {B}_{z} ( \frac{ρ}{1 - δ} ) .$$

Note that by the assumption that ρ≦δR, it follows that B′ is included in the ball

$$B := {B}_{x} ( \frac{R}{1 - δ} ) .$$

By assumption, there exists yεN such that d(x,y)=R and μ({y})>0. Thus either d(x,z) or d(y,z) is lower-bounded by R/2: indeed, by the triangle inequality,

d(x,y)=R≦d(x,z)+d(y,z).

Assume first that d(x,z)≧R/2. By the triangle inequality again, for any z′εB′, one has

d(x,z)≦d(x,z′)+d(z,z′)

so that

$$d ( x , {z}^{′} ) \geq \frac{R}{2} - \frac{ρ}{1 - δ} .$$

Note that the lower bound R/2−ρ/(1−δ) is positive under the assumptions ρ<(1−δ)/2R. In other words, for any α>0, the ball B′ is disjoint from the ball B″ defined as

$${B}^{″} := {B}_{x} ( \frac{R}{2} - \frac{ρ}{( 1 - δ )} - α ) .$$

This entails that

μ(B″)≦μ(B)−μ(B′). (13)

Let now l be an integer verifying (11). A fortiori, l is such that, for some small enough positive α,

$${2}^{𝓁} ( \frac{R}{2} - \frac{ρ}{1 - δ} - α ) \geq \frac{R}{1 - δ} .$$

This entails that

$$μ ( B ) \leq μ ( {B}_{x} ( {2}^{𝓁} ( \frac{R}{2} - \frac{ρ}{1 - δ} - α ) ) ) .$$

Applying l times the c-doubling property of μ, this inequality further implies

μ(B)≦c^{l}μ(B″).

Combined with (13), this last inequality leads to

μ(B′)≦(1−c^{-l})μ(B),

which is the desired bound (12).

Assume next that d(x,z)<R/2, so that necessarily d(y,z)≧R/2. Now for any z′εB′, by the triangle inequality one has

d(y,z)≦d(y,z′)−d(z,z′),

so that, defining now B′″ to be

$${B}^{″′} := {B}_{y} ( \frac{R}{2} - \frac{ρ}{( 1 - δ )} - α ) .$$

For some arbitrarily small α>0, the two balls B′ and B′″ are disjoint. Note further that B′″ is contained B, since for any z′″εB′″, one has

d(x,z′″)≦d(x,y)+d(u,z′″)≦R+R/2,

and the assumption δ>⅓ ensures that (3/2)R≦R/(1−δ), which is the radius of B.

Similar to (13) we thus have

μ(B′″)≦μ(B)−μ(B′).

Let now l be a positive integer verifying (11). An application of the triangle inequality implies that the inclusion

$$B ⋐ {B}_{𝓁} ( {2}^{𝓁} ( \frac{R}{2} - \frac{ρ}{1 - δ} - α ) )$$

must hold for small enough μ>0. Indeed, for any point x′εB, one has

$$d ( y , {x}^{′} ) \leq R + \frac{R}{1 - δ} = R \frac{2 - δ}{1 - δ} ,$$

and property (11) guarantees that x′ is in the corresponding ball B_{y}(2^{l}(R/2−ρ/(1−β)−α)). Finally, using l times the c-doubling property of p allows to establish that μ(B)≦c^{l}μ(B′″); combined with (13), this leads as in the previous case to the desired property (12).

Remark 1. For a given R>0, the assumptions of Lemma 2 are verified if one takes ρ=R/4, δ=⅓+ε for small enough ε>0, and l=5. Indeed, the condition ρ<min(δ,(1−δ)/2)R holds because ¼<⅓. Writing (1−δ)⁻¹=(3/2)+ε′ for some arbitrary small positive ε′, Condition (11) reads after simplification by R:

2^{l}(½−(¼)(3/2+ε′))>1+3/2+ε′,

which is clearly verified for l=5 and ε′>0 small enough.

### B. Algorithm and Upper Bound

Algorithm 2. ε-Net Content Search

Input: Oracle (·, ·, t), demand distribution μ, starting object s,
embedding ( [symbol] , d). Output: target t. 1: Initialize x₀ ← s.
2: Initial the search radius R₀ according to R₀ := [symbol] (x₀, y).
3: j ← 0.
4: while xⱼ ≠ t do
5: Construct an $( \frac{{R}_{j}}{4} ) \text{-} net$
6: By using the comparison oracle, find the closest object xⱼ₊₁ to the
target t among the points in the $( \frac{{R}_{j}}{4} ) \text{-} net and {x}_{j} .$
7: Update the search radius
Rⱼ₊₁ = inf{R: μ(Bₓ_{ⱼ₊₁}(R)) = μ(Bₓ_{ⱼ₊₁}(Rⱼ/4))}.
8: j ← j +1.
9: end while

The algorithm proposed under the present principles based on ε-nets can be found in Algorithm 2. In short, the search strategy considered proceeds in stages. These stages are denoted as j=1, . . . , S. At the beginning of a stage j, the current best exemplar is given, denoted xⱼ, and the current radius of the search, Rⱼ, which is such that in view of the selections made in previous stages, the search target is necessarily within the ball Bⱼ:=Bₓ,(Rⱼ). It is further imposed that at each stage j, the search radius Rⱼ is such that there exists a point yⱼεN such that μ({yⱼ})>0 and d(xⱼ,yⱼ)=Rⱼ, i.e., the demand distribution μ puts some mass on the boundary of Bⱼ.

The first stage is initialized by picking an arbitrary initial candidate x₁εN. The corresponding initial search radius is then defined as R₁:=sup_{yεsupp(μ)}d(x₁,y). Hence, by construction, this initial ball B₁ indeed has non-zero mass at its boundary.

The search during an arbitrary stage j proceeds as follows. The current search center xⱼ is completed by additional points of Bⱼ to form a ρⱼ-net of Bⱼ, where ρⱼ=Rⱼ/4. Then one comparison is performed between the last choice and each of the points of the net that are distinct from xⱼ. By the end of these comparisons, let x′ⱼ be the last selection of the user. Clearly, this selection is among the points of the net, that which is closest to the target of the search.

Since (in view of Lemma 1) the union of balls centered at the points of the net, and with radius ρⱼ, covers entirely the current search ground Bⱼ, it follows that necessarily the target must lie in the ball B_{x′j}(ρⱼ).

One last operation is needed to specify how the next stage j+1 is initialized. The center of search at stage j+1 will be set to xⱼ₊₁:=x′j. Tt is known that the target lies within Bₓⱼ₊₁(ρⱼ). Then, specify the search radius Rⱼ₊₁ to be the smallest R such that μ(Bₓⱼ₊₁(R))=μ(Bₓⱼ₊₁(μⱼ)). Thus necessarily, Rⱼ₊₁≦ρⱼ, and moreover the minimality of Rⱼ₊₁ implies that measure μ puts some mass on the boundary of the resulting search ball Bⱼ₊₁. As such, this method has indeed ensured by construction that at any stage j (a) the target lies in the current ball Bⱼ and (b) the ball contains an object of non-zero mass at its boundary.

The number of queries submitted to the oracle can be bounded by Algorithm 2.

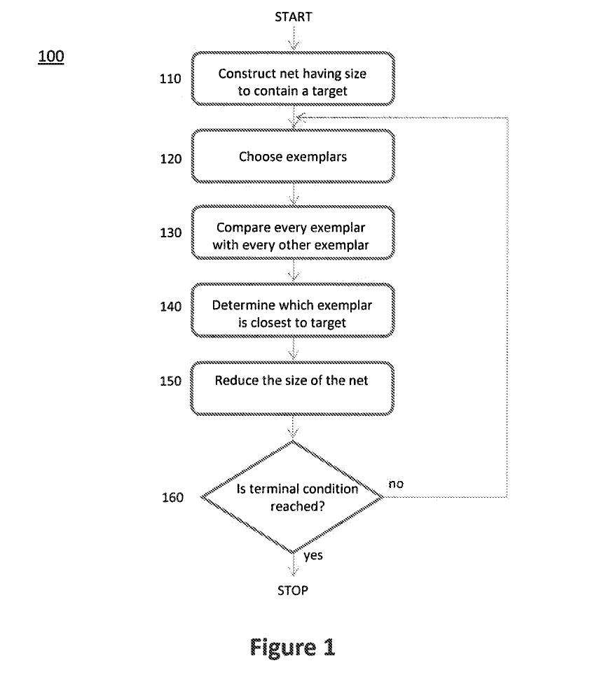

Algorithm 2 is a greedy algorithm that uses the history of the search to propose new objects. One embodiment of a method 100 under the present principles is shown in FIG. 1. The method comprises a step 110 of constructing a net of certain size. This net is constructed in a way that ensures to contain the target (think of it as a ball containing a point inside). The method is further comprised of a step 120 of choosing a few exemplars and also comprised of a step 130 for comparing the exemplars with one another. The exemplar that is closer to the target is chosen in step 140 and then another net with a smaller size (i.e., a smaller ball) is again constructed in step 150 around this object. The method must ensure that the target is contained in the net. This process is repeated until a terminal condition is reached in step 160, such as locating the target. If the terminal condition has been reached, the target is locatable within the net and the method stops. If the terminal condition has not been reached, the method reverts back to step 120 and chooses exemplars with the smaller net size.

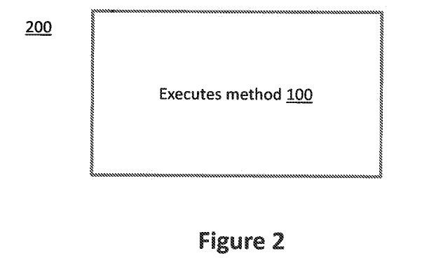

One embodiment of an apparatus 200 to perform a content search is shown in FIG. 2. The apparatus is comprised of a computer that executes the method 100.

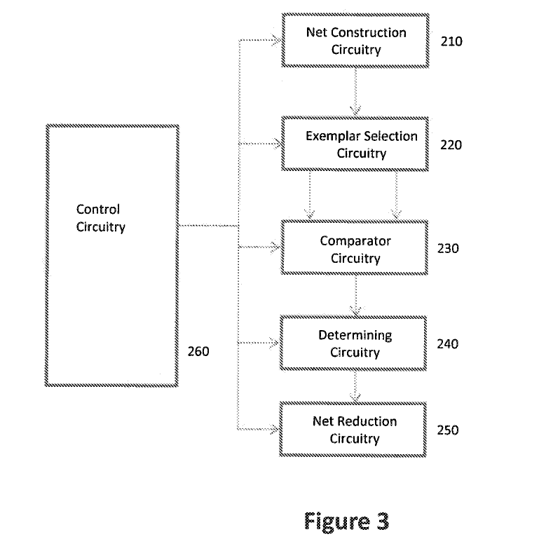

One embodiment of the details of apparatus 200 for searching content is shown in FIG. 3. The apparatus comprises Net Construction Circuitry 210. This net is constructed in a way that ensures to contain the target. The apparatus further comprises Exemplar Selection Circuitry 220. The apparatus also comprises Comparator Circuitry 230. Comparator Circuitry 230 can compare exemplars in pairs, or all at once, depending upon resource and/or time availability. The apparatus also comprises Determining Circuitry 240. Determining Circuitry 240 determines which of the exemplars is closest to the target. Determination can be performed in one or more variety of ways, such as absolute difference, etc. The apparatus further comprises Net Reduction Circuitry 250. Net Reduction Circuitry 250 must ensure that the target is still contained in the net, while reducing the size of the net. This process is repeated until a terminal condition is reached. The apparatus also comprises Control Circuitry 260 which is used to control the operation of the various elements and, in particular, controls the number of iterations that the elements perform in order to reduce the net to the terminal condition, which is monitored by the control circuitry.

The terminal condition can be one condition or a combination of conditions. For example, one possible condition is that the net is small enough to locate the target. Another possible condition is that the size of the net is within a threshold value. Another possible condition is that the loop in method 100 is performed a predetermined number of times. Another possible condition is that the target itself is chosen when determining the exemplar closest to the target.

In a further embodiment, the size of the net can be reduced by carrying out repeated operations of the loop until the net is reduced, and then an alternative method can be used to actually locate the target within the reduced size net. This embodiment may be used, for example, when it is more computationally efficient to do the final selection with the alternative method rather than performing more iterations of the loop.

Theorem 3. The expected search cost of Algorithm 2 can be bounded by

$${\overline{C}}_{F} \leq ( {c}^{5} - 1 ) ( 1 + \frac{H ( μ )}{log ( 1 / ( 1 - {c}^{- 5} ) )} ) . \qquad ( 14 )$$

At each stage j one comparison is performed between the last choice and each of the points of the ρⱼ-net that are distinct from xⱼ. The size of this ρⱼ-net is, by Lemma 1, at most c⁵. Thus, at most c⁵−1 binary comparisons are needed at each stage.

Denote again by x′ⱼ the last selection at stage j. Also denote by πⱼ:=μ(Bₓⱼ(R_{f}(1−δ))) the mass put by measure p on the search ground Bⱼ, after enlarging its radius by a factor 1/(1−δ), where δ=⅓+ε, for some small ε chosen as in Remark 1. It now follows by Lemma 2 and Remark 1 that necessarily,

μ(Bₓ_{ᵢ}^{_{y}}(ρⱼ/(1−δ)))≦(1−^{-β})πⱼ,

Note also that, critically, by Lemma 2 and an induction argument, it is guaranteed that at each stage j of the search

πⱼ=μ(Bₓ_{ⱼ}(Rⱼ/(1−δ)))≦(1−c⁻⁵)^{j-1}.

Then place the condition on the target element zεN. Considering its probability μ({z}) and the previous bound on the probability of the search range after j stages, clearly the search will have completed after j stages provided

(1−c⁻⁵)ⁱ⁻¹≦μ({ [symbol] }),

or equivalently, provided

$$j \geq 1 + \frac{log ( 1 / μ ( \{ z \} ) )}{log ( 1 / ( 1 - {c}^{- 5} ) )} .$$

The average number of stages, S, is then upper-bounded by

$$\overline{S} \leq {\sum }_{z ∈ N}^{ } μ ( \{ z \} ) ( 1 + \frac{log ( 1 / μ ( \{ z \} ) )}{log ( 1 / ( 1 - {c}^{- 5} ) )} ) = 1 + \frac{H ( μ )}{log ( 1 / ( 1 - {c}^{- 5} ) )} .$$

Noting that, within a stage, at most c⁵−1 comparisons are performed, the upper-bound (14) follows.

It is noted that Theorem 3 gives an upper bound which is matching lower bound (7), up to a discrepancy in the exponent of the doubling constant c. In contrast to Algorithm 1, which could be implemented only using ordering relationships between objects rather than exact distances, Algorithm 2 indeed requires full knowledge of the underlying metric space. Interestingly, Algorithm 2 does not require knowledge of the target distribution μ. All steps in the algorithm (and, in particular, the shrinking of the ball Bⱼ to ensure it has non-zero mass at the boundary) can be implemented as long as the support supp(μ) is known.

### CONCLUSIONS

The principles described herein provide a solution to the problem of content search through comparisons (CSTC) under heterogeneous demands, tying performance to the topology and the entropy of the target distribution. The search strategy considered in Algorithm 2 relies on the construction of ε-nets at different stage of the search, which necessitates access to detailed information about the geometry of the search space (M,d), but no information about the demand distribution μ.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method for searching content within a data base, comprising the steps of:
constructing a net having a size that contains a target;
choosing a plurality of exemplars;
comparing each exemplar with every other exemplar;
determining the exemplar closest to the target;
reducing the size of the net to a smaller size that contains the target;
repeating said choosing, comparing, determining, and reducing steps until the size of the net is small enough to locate the target.

2. The method of claim 1, wherein said repeating step is performed for at least two iterations.

3. The method of claim 1, wherein said repeating step is performed until the size of the last net is within a threshold value.

4. The method of claim 1, wherein said repeating step is performed for a predetermined number of iterations.

5. The method of claim 1, wherein the target is located by an alternative search method after the net becomes small enough.

6. A computer for searching content within a data base, comprising:
circuitry to construct a net having a size that contains a target;
circuitry to choose a plurality of exemplars;
comparator circuitry that operates on the exemplars;
a determining circuit that finds the exemplar closest to the target;
circuitry to reduce the size of the net to a smaller size that contains the target; and
control circuitry to cause said circuitry to construct, said circuitry to choose, said comparator, said determining circuit, and said circuitry to reduce to repeat their operation until the size of the net is small enough to locate the target.

7. The apparatus of claim 6, wherein said control circuitry causes said circuitry to construct, said circuitry to choose, said comparator circuitry, said determining circuit, and said circuitry to reduce to repeat their operation for at least two iterations.

8. The apparatus of claim 6, wherein said control circuitry causes said circuitry to construct, said circuitry to choose, said comparator circuitry, said determining circuit, and said circuitry to reduce to repeat their operation until the size of the last net is within a threshold value.

9. The apparatus of claim 6, wherein said control circuitry causes said circuitry to construct, said circuitry to choose, said comparator circuitry, said determining circuit, and said circuitry to reduce to repeat their operation until the size of the last net is within a threshold value.

10. The apparatus of claim 6, wherein said control circuitry causes the target to be located by an alternative search method after the net becomes small enough.
